(19) United States
(12) Patent Application Publication
(10) Pub. No.: US 2026/0358362 A1
(43) Pub. Date: Nov. 12, 2026

(54) METHOD AND MICROSCOPE FOR DETERMINING PROPERTIES OF MOVING OBJECTS IN A BIOLOGICAL SAMPLE

(71) Applicant: Carl Zeiss Microscopy GmbH, Jena (DE)

(72) Inventors: Stanislav Kalinin, Weimar (DE); Georg Wieser, Weimar (DE); Annette Bergter, Jena (DE); Volodymyr Kudryavtsev, Jena (DE)

(73) Assignee: Carl Zeiss Microscopy GmbH, Jena (DE)

(21) Appl. No.: 19/668,217

(22) Filed: May 5, 2026

(30) Foreign Application Priority Data
May 6, 2025 (DE) 10 2025 117 319.2

(51) Int. Cl. G01P 3/38; G01P 13/02; G02B 21/00

(52) U.S. Cl. CPC G01P 3/38; G01P 13/02; G02B 21/0084; G02B 21/0076

(57) ABSTRACT

A method determines properties of large moving objects in a biological sample and includes detecting detection radiation from a confocal volume generated in the sample using a plurality of detector elements of a detector in the form of a detector array at multiple points in time over a measurement period and the measurement values from the detector elements can be analyzed individually. Multiple pairs of detector elements are selected and respective imaginary connecting lines between the centers of the pairs or extended pairs have at least two mutually different orientations. Cross-correlations are created for the acquired measurement values from the detector elements among themselves. A time offset (t_{delay}) is ascertained between signal patterns of the detector elements of the pairs or extended pairs, and a movement direction and/or a movement speed of an object are calculated. A microscope carries out the method.

### CROSS-REFERENCE TO RELATED APPLICATIONS

This U.S. patent application claims priority to German Patent Application No. DE 10 2025 117 319.2, filed on May 6, 2025, the content of which is hereby incorporated by reference in its entirety.

### BACKGROUND OF THE INVENTION

### Field of the Invention

The invention relates to a method for determining properties of moving objects in a biological sample. The invention also relates to a microscope suitably configured for carrying out the method.

### Description of Related Art

Fluorescence correlation spectroscopy (FCS) is a method from the field of confocal scanning microscopy, especially confocal laser scanning microscopy, which has proven its worth, for example for examining the dynamics of the behavior of molecules in cells.

The method, also abbreviated FCS below, has been continually developed further, and so different variants of FCS are available (e.g. Lenne et al., 2006; EMBO J. 25: 3245-3256 and Wenger et al., 2007; Biophys. J. 92: 913-919). One of the variants is what is known as “spot-variation FCS” (e.g. Wawreznieck et al., 2005; Biophys. J. 89: 4029-4042).

In the process, excitation radiation is focused and directed at a sample. As a result of the focusing and the extent of the focus of the focused beam of the excitation radiation both transversely (x- or y-direction) to the propagation direction (usually optical axis) and along the propagation direction (z-direction), what is known as a confocal volume (also referred to in this context as “focus” for simplicity) is illuminated in the sample in conjunction with confocal detection.

Pieces of brightness information (measurement values) can be acquired for confocal volumes of different sizes. To this end, the numerical aperture (NA) of an objective used for illumination purposes can be varied, wherein for example a changeable iris diaphragm, different pinholes arranged on a revolver or a slider, or a telescope is/are present in the excitation beam path and controlled accordingly. The brightness information is acquired by means of an optical detector (e.g. photodiode).

The publication by Scipioni et al. (2018; Nature Communications; DOI: 10.1038/s41467-018-07513-2) has disclosed a modification of the spot-variation FCS. For detection purposes, use is made of a spatially resolving surface detector, the detector elements of which can be read and evaluated individually and independently of one another. Specifically, a detector type referred to as an “Airyscan detector” is used in Scipioni et al.; it is arranged in an intermediate image plane of a detection beam path and the respective detector elements thereof act as individual pinholes (Huff, 2015, Nature Methods; Application Notes, December 2015). In this method configuration, pieces of brightness information from selected detector elements are evaluated, with virtual pinholes of different sizes being simulated by the selection of the detector elements. In this way, it is possible—virtually—to create varying confocal measurement volumes even though the actually illuminated confocal excitation volume remains constant. The procedure according to the publication by Scipioni et al. allows the simultaneous acquisition of brightness information from up to four different measurement volumes using a single measurement.

In a further development of the FCS methods, DE 10 2023 201 620 B3 describes a possibility by means of which statements relating to the speed and direction of detected diffusion processes and movements of molecules can be ascertained. The teaching of DE 10 2023 201 620 B3 assumes that the fluorescent objects are small in comparison with the cross section of the confocal volume, and they do not fill the cross section.

By contrast, if moving objects should be observed, for example in living organisms, tissues or organoids, then the liquid or flowing regions of these moving objects often also contain objects which are larger than the cross section of the confocal volume. Examples of such applications include the measurement of the blood flow with the large blood cells contained in the blood and measurements in plant media with chloroplasts contained therein.

Measurements in which such large objects occur are often inaccurate and tend in particular to underestimate the flow rates, in some cases by one or more orders of magnitude.

### SUMMARY OF THE INVENTION

The problem addressed by the invention is that of indicating a possibility by means of which movement information can be obtained from objects which are greater than an imaged confocal volume.

The invention includes but is not limited to the following embodiments:
1. A method for determining properties of moving objects in a biological sample,
the method comprising:
A. detecting detection radiation from a confocal volume generated in the sample using a plurality of detector elements of a detector in the form of a detector array at multiple points in time over a measurement period, wherein the detector is arranged in a plane conjugate to the rear-side image plane of an objective and the measurement values from the detector elements are configured to be analyzed individually; and selecting at least one pair of detector elements, each partner of a pair being formed by at least one detector element or a plurality of detector elements being combined to form a respective one of the partners of an extended pair;
B. creating cross-correlations of the acquired measurement values from the detector elements of at least one pair or of the extended pair among themselves, wherein
in B, in B1, cross-correlations are calculated in a first direction to the further selected detector element starting from one of the selected detector elements;
in B, in B2, cross-correlations are additionally calculated in a second direction (back direction) to the first selected detector element starting from the further selected detector element;
C. defining multiple pairs or multiple extended pairs of detector elements, wherein the respective imaginary connecting lines between the centers of the pairs or extended pairs have at least two mutually different orientations;
D. ascertaining a time offset between signal patterns of the detector elements of the pairs or extended pairs; and
E. calculating a movement direction and/or a movement speed of an object on the basis of the ascertained time offsets of pairs or extended pairs, the associated connecting lines of which have different orientations.
2. The method according to embodiment 1, wherein each of the imaginary connecting lines has one of a total of three different orientations.
3. The method according to embodiment 2, wherein the orientations of the imaginary connecting lines are rotated by 120° relative to one another in each case.
4. The method according to embodiment 1, wherein the partners of a pair are spatially separated by at least one detector element not belonging to the pair in question.
5. The method according to embodiment 1, wherein a group of multiple pairs or multiple extended pairs of detector elements is defined, wherein the imaginary connecting lines of the centers of the pair pairs or extended pairs run parallel to one another.
6. The method according to embodiment 1, wherein-a mean value is formed from the cross-correlations of the first direction and/or the second direction created from the measurement values from the pairs or extended pairs.
7. The method according to embodiment 1, wherein for each orientation of the imaginary connecting lines, intensity profiles (intensity traces) of detector elements are created, cross-correlations are calculated therebetween and an ascertained maximum of the cross-correlations is stored as a time offset (t_{delayi}) in the respective orientation.
8. The method according to embodiment 1, wherein an autocorrelation is ascertained for the detector elements of a pair, an extended pair or a group using a fitting model; and cross-correlations with the time offset (t_{delayi}) are calculated as fit parameters on the basis of the autocorrelations between the partners of the pair, of the extended pair or of the group ascertained in each case.
9. The method according to embodiment 8, wherein the following relationship is used

$${G}_{f l o w} ( τ ) = A exp ( - \frac{{τ}^{2}}{{t}_{f}^{2}} )$$

as the fitting model, where t is the correlation or “lag” time, A is the amplitude of the correlation and tr is the mean dwell time of the object in the confocal volume.
10. The method according to embodiment 8, wherein a size distribution and/or of movement profiles of the objects is additionally integrated in the fitting model.
11. The method according to embodiment 1, wherein cross-correlation curves for the first direction and for the second direction are created on the basis of the cross-correlations between the detector elements of at least one pair per orientation, and a time shift is ascertained for the cross-correlation curves, wherein the time shift corresponds to twice the time offset (t_{delayi})
12. A microscope for determining properties of moving objects in a biological sample, the microscope comprising:
a sample region for arranging a biological sample;
an objective for capturing a detection radiation coming from a confocal volume created in the sample;
a detection beam path along which the captured detection radiation is directed to a detector in the form of a detector array having a plurality of detector elements, wherein the detector is arranged in a plane conjugate to the rear-side image plane of the objective, and the measurement values from the detector elements each are configured to be read individually; and
an analysis and control unit configured for carrying out the method according to embodiment 1.

### BRIEF DESCRIPTION OF THE DRAWINGS

FIG. 1 shows an exemplary illustration of signal profiles of two detector elements that have a time offset relative to one another.

FIG. 2 shows a schematic illustration of a first example of a detector array.

FIG. 3 shows a schematic illustration of a second example of a detector array.

FIG. 4 shows a schematic illustration of an exemplary embodiment of a microscope according to the invention.

FIG. 5 shows a schematic illustration of a detector array and pairs of detector elements selected by way of example.

FIG. 6 shows a schematic illustration of the detector array and a group of selected pairs of detector elements.

FIG. 7 shows a schematic illustration of a detector array and an extended pair of detector elements selected by way of example.

FIG. 8 shows an example of two cross-correlation curves and their time offset.

FIG. 9 shows a diagram of a configuration of the method according to the invention.

### DETAILED DESCRIPTION OF THE INVENTION

The problem is solved by the subjects of the independent embodiment and alternative independent embodiment. The dependent embodiments relate to advantageous developments. In particular, the object is achieved by a development of the technical procedure disclosed in DE 10 2023 201 620 B3.

The steps set forth below are encompassed by the method according to the invention for determining properties of moving objects in a sample, in particular in a biological sample. A detection radiation whose origin is in a confocal volume created in the sample is detected in a step A. Detection is implemented using a plurality of detector elements of a detector array at multiple points in time over a measurement period (measurement time period, measurement interval, for example 10 seconds to a few minutes per measurement period in each case), wherein the detector array is arranged in a plane conjugate to the rear-side image plane of an objective (also referred to as “pinhole plane”). The measurement values from the detector elements can each be analyzed on an individual basis. It is also possible to combine the measurement values from respective selected detector elements with one another (“binning”).

At least one pair of detector elements is selected in a step B of the method according to the invention, wherein each partner of a pair is formed by at least one detector element. Cross-correlations of the acquired measurement values are created among themselves from the measurement values of at least one pair. In the process, in a first sub-step B1 cross-correlations are calculated in a first direction to the further selected detector element starting from one of the selected detector elements. This first direction can also be referred to as forward direction.

In a second sub-step B2, cross-correlations are additionally calculated in a second direction (back direction) to the first selected detector element starting from the further selected detector element.

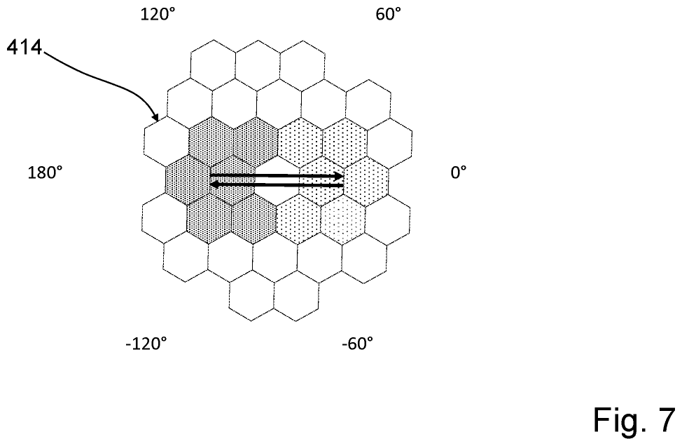

The development according to the invention of the procedure specified above is characterized in that in a step C, multiple pairs or multiple extended pairs (see below; see also FIG. 7) of detector elements are defined, wherein the respective imaginary connecting lines between the centers of the respective detector elements of the pairs or extended pairs have at least two mutually different orientations, advantageously three different orientations. In a step D, a time offset is ascertained between signal patterns or measurement values, in particular intensity values, of the detector elements of the pairs or the detector elements of the extended pairs. A movement direction and/or a movement speed of an object are calculated in a step E on the basis of the time offsets occurring in the pairs or extended pairs.

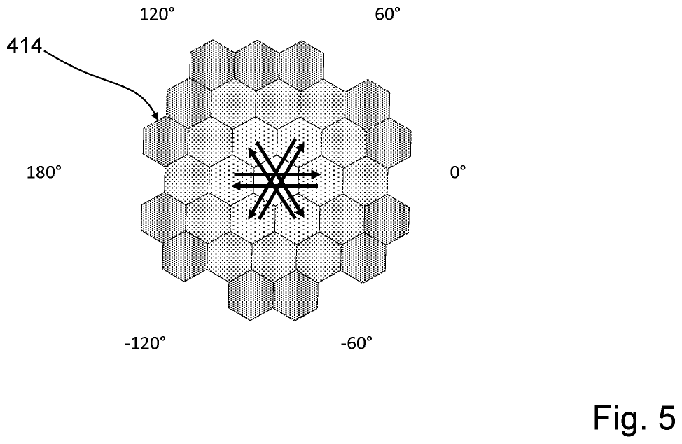

Within this description, the term direction is used within the sense of a vector having a starting point and a virtual propagation line. This means that in a horizontal, for example, a first direction (forward direction) runs toward 0° from a starting point and a second direction (back direction) runs toward 180° from a starting point (see also FIG. 5). A corresponding statement applies to (polar) coordinate systems with a different reference system.

An orientation is understood to mean the basic alignment of imaginary connecting lines. In this case, the respective associated first and second directions have the same orientation. For example, a first direction from 180° to 0° and a second direction from 0° to 180° are collectively associated with a horizontal orientation. An orientation can be regarded as a virtual axis of the detector (detector axis), along which there is a specific measurement value acquisition or evaluation (correlation direction).

Starting from the procedure disclosed in DE 10 2023 201 620 B3 and on the basis of an adapted evaluation of measured values acquired, the essence of the invention is that of ascertaining both movement directions and movement speeds of large objects. In this case, use can be made of the fact that stochastic diffusions of large objects such as e.g. cells, in particular blood cells, can be neglected over the time periods relevant in FCS measurements.

In particular, cells, conglomerates or particles larger than the cross section of an observed confocal volume or larger than an image field of a detector used are referred to as large objects in the context of this description.

The size of such objects means that, when they flow through the confocal volume, most or all of the detector elements of the detector are influenced by the object with a time offset relative to one another. The movement direction and the movement speed of the object determine the sequence of the influenced detector elements and the time offset between the detection events of the detector elements under consideration. In contrast to small objects, such as molecules labeled with fluorophores, large objects influence multiple detector elements simultaneously during their flow through the confocal volume.

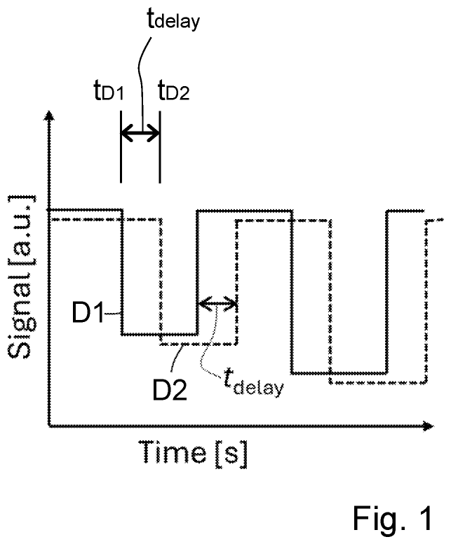

This circumstance is illustrated by way of example in FIG. 1. The signal profiles (y-axis: arbitrary units [a.u.]) of two detector elements D1 and D2 of a pair are plotted over a time period (time [s]). From the example of the detector element D1, the signal profile of which is represented by the solid line, it is evident that its signal amplitude decreases significantly over two periods of time, which moreover last for different lengths, in order then to rise again to the initial intensity. Signal profiles according to FIG. 1 can be obtained, for example, if two objects, which do not emit fluorescence themselves, shield or at least reduce a measured fluorescence over the two mentioned time periods.

The second detector element D1 (dashed line) shows the same signal path curve. However, the changes in the signal strength or the amplitude of the second detector element D2 vis-à-vis the first detector element D1 are effected with a time offset, which is also referred to below as t_{delay}. It is evident from the example of FIG. 1 that a reduction in the signal strength of the first detector element D1 takes place at a time tp1. The corresponding reduction in the signal strength of the second detector element D2 is measured at a time tp2. The difference between tp1 and tp2 corresponds to the time offset t_{delay}.

In another experimental arrangement, the high signal strengths can be measured when fluorescent objects move through the confocal volume and influence the measurement values of the individual detector elements D1 and D2 in succession. The principle of influencing the detector elements of the detector with a time offset remains the same.

Unlike in the prior art, an already existing configuration of an optical arrangement, for example of a microscope, can be used to carry out the invention in order to ascertain data without additional equipment outlay. Use is made here of the circumstance that each of the detector images a slightly different portion of the confocal volume. Thus, a plurality of mutually different detection foci are generated and their measurement values are analyzed, wherein the very high precision of the manufacture and arrangement of the detector elements and also of the optical elements upstream thereof, for example microlens arrays, in what are known as Airyscan detectors (Huff, 2015, Nature Methods; Application Notes, December 2015) and arrays of SPAD (single photon avalanche diode) detectors advantageously require a very precise knowledge of the distances of the respective confocal volumes. Compared with the solutions from the prior art, the exact knowledge with regards to the position and nature of the respective confocal volumes advantageously allows a calibration thereof, for example using known dye molecules as references, to be dispensed with.

The basic procedure according to the invention is explained by way of example below on the basis of an Airyscan detector with 32 channels (Huff, 2015, Nature Methods; Application Notes, December 2015).

As may be gathered by way of example from FIG. 5, the use of the Airyscan detector allows six cross-correlations to be calculated if a respective detector element spacing remains between the detector elements that form a pair and if the outer detector elements are unused (see below). In this case, a difference between the cross-correlations calculated for opposite first or second directions indicates a movement of an object that causes or emits detection radiation.

The orientations of the imaginary connecting lines are advantageously rotated relative to one another by the same amounts. For a sufficient coverage of all possible orientations with at the same time acceptable computational outlay, the orientations can for example be rotated by 120° relative to one another in each case, as is shown in FIG. 5. In further possible configurations of the invention, the orientations can be rotated by smaller angular amounts. In addition, it is possible in principle for the orientations to be rotated by different angular amounts.

In order to determine a speed and a direction of a small moving object as per DE 10 2023 201 620 B3, it is possible to create an experimental cross-correlation of the form specified with regard to Equation (1) or by means of more detailed models.

The equation in relation to (1) is:

$$G ( τ ) = A exp ( - \frac{{r}_{0}^{2} + {τ}^{2} {v}^{2} - 2 {r}_{0} τvcosα}{4 D τ + {w}_{0}^{2}} ) {G}_{diff} ( τ ) \qquad ( 1 )$$

where v is the flow speed (fit parameter); α is an angle between the flow direction and a vector connecting the detector elements (fit parameter); r₀ is the distance between the foci of the detector elements of an (extended) pair; w₀ is the 1/e² radius of the confocal volume in xy for a detector element; D is the diffusion coefficient and G_{diff}(τ) is the diffusion term (2-D or 3-D). The latter describes the autocorrelation in the absence of a movement for a detector element.

The parameter r₀ cannot be calculated directly from the spacing between the detector elements; instead, it must be determined empirically or theoretically. The reason for this can be found in the circumstance that the PSF (point spread function) of the illumination radiation and the PSF of the detection radiation are not the same. On the one hand, the parameter r₀ can be determined by virtue of a static sample, for example a color solution, being measured, wherein r₀ is inserted as parameter to be fitted and the flow speed is set to v=0. Alternatively, r₀ can be derived from a theoretical PSF, for example by using cross-correlations with the theoretical PSF and adjusting (“fitting”) them by means of equation (1).

Fitting multiple cross-correlations for different orientations improves the stability of the fits with regard to the angle α. Unlike the case of a two-focus FCS, it is moreover possible to determine all cross-correlations from a single set of measurement values. While equation (1) is used for small objects, multiple cross-correlations for different orientations can also be fit within the scope of the method according to the invention.

In a further method configuration, it is possible for a plurality of detector elements to be combined to form a respective one of the parts or partners of a pair in each case; this is referred to below as extended pair (see also FIG. 7). In this case, the acquired measurement values per partner of the extended pair are mathematically combined, for example averaged, before a cross-correlation is determined between the measurement values, thus mathematically combined, of the two partners of the extended pair.

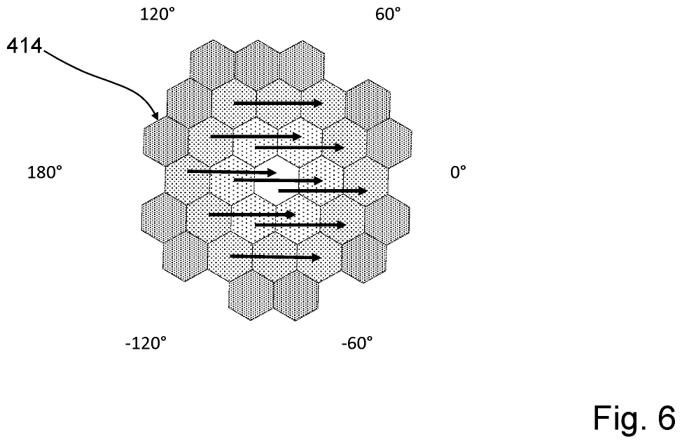

The method according to the invention can be implemented using multiple pairs or using only one extended pair of detector elements. To improve the signal-to-noise ratio, a group of a plurality of pairs and/or extended pairs of detector elements can be defined in a further configuration. In this case, the imaginary connecting lines of the centers of the detector elements of each pair or each extended pair run substantially parallel to one another. Although the imaginary connecting lines may, merely by way of example, start at centers of different detector elements, they all run toward 0° for example (see also FIG. 6). For small objects, Equation (1) can again be applied to the measurement values from the pairs selected thus after the measurement values acquired per pair were averaged. Similar applies to the second direction, i.e. the back direction, for example toward 180°. In these cases, the forward direction can also be referred to as the common first direction and the back direction can also be referred to as the common second direction. To ascertain the movement speed and/or movement direction of large objects in the sense of the description, a modified procedure, which is explained further below, has instead been found within the scope of the invention.

For more in-depth analyses and/or calculations in particular, a mean value of the cross-correlations in the first direction and/or second direction, created from the measurement values of the pairs or extended pairs, can be formed in each case.

An advantage of the method according to the invention lies in the circumstance that a plurality of pairs or extended pairs can be analyzed at the same time. Groups of pairs or extended pairs are advantageously analyzed in this case, wherein the respective common orientations of the imaginary connecting lines between the (extended) pairs of each of the groups are different from one another.

In an advantageous configuration of the method according to the invention, multiple cross-correlations can be calculated, for example, via pairs/extended pairs of different orientations, for example at least two different groups, or their mean values (see above). Optionally, all curves obtained thus can be fitted with the corresponding directions, orientations and/or speeds as parameters (global fit).

When selecting the detector elements of the respective pairs/extended pairs, it is possible to map a sufficient diffusion path or flow path by virtue of the selected pairs having been spatially separated in each case by at least one detector element not belonging to the relevant pair. Accordingly, the detector elements belonging to an extended pair may be selected to be distant from one another by at least the distance corresponding to the width of a detector element.

As will be explained below, the detector elements that have a sufficiently similar radius of the confocal volume and whose distances from one another are the same should be chosen in particular. This means that measurement values from the detector elements at the edge are either evaluated separately or discarded.

To increase the efficiency of the method according to the invention, it is possible to shape a point spread function (PSF) of illumination radiation used to create the confocal volume and directed along an illumination beam path into the sample chamber and/or of the detected detection radiation such that, in particular, the detector elements which are provided or suitable as partners of the pairs or extended pairs for a subsequent analysis acquire measurement values.

For example, the cross section of the illumination beam path can be stretched in a direction transversely to the respective beam path such that it has an elongate-oval cross section. Such beam shaping can be attained by means of a suitable slit stop or by the effect of an appropriately controlled spatial light modulator (SLM).

The time offset already mentioned above can be ascertained in various ways within the meaning of the invention.

In a first variant of the method according to the invention, intensity profiles (intensity traces) of detector elements are generated per orientation of the imaginary connecting lines, as is shown by way of example in FIG. 1. Cross-correlations are calculated therebetween, and a determined maximum of the cross-correlations is stored as a time offset t_{delay} in the respective orientation. For example, if pairs of detector elements whose connecting lines have three different orientations (for example, see FIG. 5) are selected, a time offset is obtained for each of the orientations, for example t_{delay0}, t_{delay60} and t_{delay120}. The indices represent the orientations in this case—0°, 60° and 120° in this example.

In a further configuration of the method according to the invention (variant 2), an autocorrelation is calculated in each case for the detector elements of a pair, an extended pair or a group, or for the measurement values thereof. Here,

$${G}_{f l o w} ( τ ) = A exp ( - \frac{{τ}^{2}}{{t}_{f}^{2}} ) \qquad ( 2 )$$

can specify a suitable model. In this case, t is the correlation or “lag” time, A is the correlation amplitude and t_{f} denotes the mean dwell time of the object in the observed confocal volume.

On the basis of the respectively ascertained autocorrelations for the detector elements of the pair, of the extended pair or of the group, cross-correlations with the time offset are calculated as fit parameters. The cross-correlations in the first and second directions of each orientation of the connecting lines can be expressed as:

G_{cross}(τ)=G_{flow}(τ±t_{delay}) (3)

In further embodiments of variant 2, information relating to the known or expected cell size distribution of the sample can be taken into account. Moreover, it is possible for already known or expected movement profiles of the large objects, which are caused for example by their shape, surface condition and/or dimensions, to be taken into account.

It is also possible for Equations (2) and (3) to be integrated into the calculation of the cross-correlations, for the time offset to be defined as a fit parameter and for a global fit to be calculated over all cross-correlations or the cross-correlation curves.

If t_{delay} is expressed as a function of υ (movement speed) and πᵢ (angle between the flow or movement direction and a respective imaginary connecting line; see also Equation 4) for example, then these can be determined in the course of a global fit.

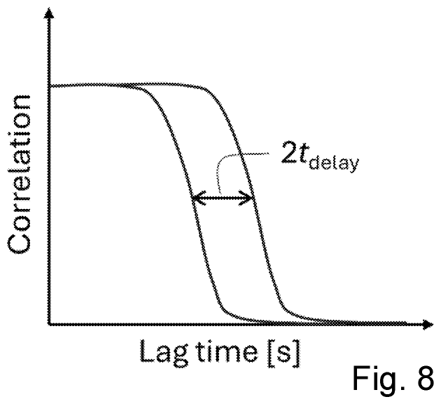

The cross-correlation curves can also be used in the context of a third way of ascertaining the time offset (variant 3). Cross-correlation curves for the first direction and for the second direction are generated per orientation on the basis of the calculations of the cross-correlations between the detector elements of at least one pair. A time shift of the cross-correlation curves in the first or second direction can be ascertained graphically or computationally on the basis of the curves. In this case, the time shift of the curves corresponds to twice the time offset (see also FIG. 8).

Compared to variant 1, variants 2 and 3 offer the possibility of analyzing averaged correlation curves, which leads to an improved signal-to-noise ratio (SNR).

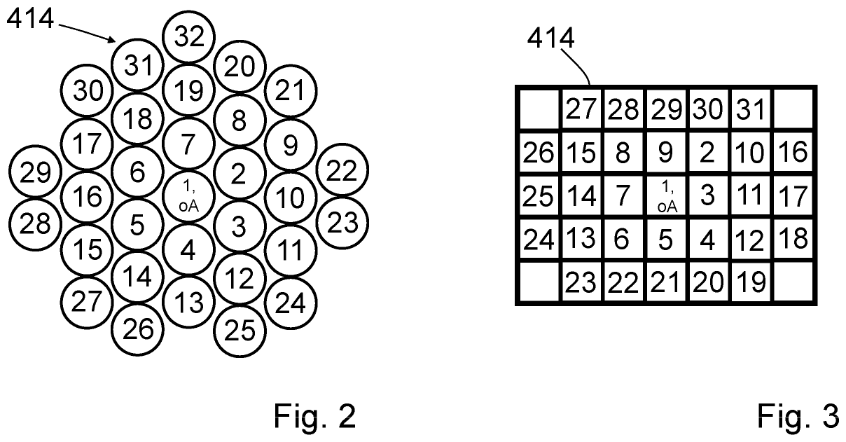

According to each of the variants 1 to 3, a time offset t_{delay} can be ascertained for each of the selected orientations of the imaginary connecting lines. The time offsets of the i alignments (correlation directions) can be denoted by t_{delay i} with i=1, 2, 3. In particular, an arrangement of the selected detector elements with approximately equal distances from one another is assumed here, as is the case, for example, for a hexagonal arrangement (for example, see FIG. 2 and FIG. 5 to FIG. 7) of the detector elements.

In an advantageous embodiment, three alignments—180°->0° with an angle φ0°, 60°->−120° with an angle φ120° and 120°->−60° with an angle φ240° (see also FIG. 5)—are chosen, and time offsets t_{delay1}, t_{delay2} and t_{delay3} are ascertained accordingly. The following applies to each of the orientations:

υ·t_{delayi}=r₀ cos αᵢ (4)

Here, υ denotes the movement speed, αᵢ denotes the angle between the flow direction or movement direction and the respective imaginary connecting line (expressed as vector) and r₀ denotes the distance between the foci of the detector elements.

For the three orientations (detector axes) with the angles φ0°, φ120° and φ240° (generalized: φ₁, φ₂ and φ₃), the movement speed υ and the movement direction α can be calculated separately. For example, a system of equations

$${r}_{0} [ \begin{matrix}cos ( {φ}_{1} ) & sin ( {φ}_{1} ) \\ cos ( {φ}_{2} ) & sin ( {φ}_{2} ) \\ cos ( {φ}_{3} ) & sin ( {φ}_{3} )\end{matrix} ] * [ \begin{matrix}{v}_{x} / \vert v {\vert}^{2} \\ {v}_{y} / \vert v {\vert}^{2}\end{matrix} ] = [ \begin{matrix}{t}_{d e l a y 1} \\ {t}_{d e l a y 2} \\ {t}_{d e l a y 3}\end{matrix} ] \qquad ( 5 )$$

can be solved using the least squares method. The indices x and y represent mutually orthogonal directions transverse to the z-direction of the confocal volume and in the detection plane given by the detector elements.

Subsequently, the movement speed υ can be calculated using the equation:

$$v = \sqrt{{v}_{x}^{2} + {v}_{y}^{2}} \qquad ( 6 )$$

and the equation:

$$a = a tan ( \frac{{v}_{y}}{{v}_{x}} ) \qquad ( 7 )$$

can be used to calculate the direction of movement a.

A microscope for determining properties of moving objects in a biological sample can be used to carry out the method according to the invention. Said microscope comprises a sample region for arranging the biological sample; an objective for capturing detection radiation coming from a confocal volume generated in the sample and a detection beam path along which the detected detection radiation is directed to a detector array with a plurality of detector elements, wherein the detector array is arranged in a plane conjugate to the rear-side image plane of the objective (image plane; pinhole plane) and the measurement values from the detector elements can be read individually. The plane is in particular an intermediate image plane in which at least one pinhole is arranged in a confocal detection beam path. In a microscope according to the invention, the function of the pinhole is fulfilled by the individual detector elements of the detector.

As a detector, one of the already mentioned Airyscan detectors or SPAD arrays can advantageously be present. Optical elements such as microlens arrays, for example, may be placed in front of the detector elements.

The microscope according to the invention also comprises an analysis unit configured for carrying out the method according to any of the method embodiments. Such an analysis unit may be, for example, a computer, a microcontroller or an FPGA.

The method according to the invention can be advantageously supported by adapting the beam shape of the illumination radiation or the detection radiation according to the current requirements. To this end, a controllably adjustable iris stop can be arranged for example as a beam-shaping optical unit in the illumination beam path or in the detection beam path of the microscope. For example, a reduction in the diameter of the illumination beam path brings about underfilling on the input side of the objective pupil and hence leads to an increase in the confocal volume.

In an embodiment of the microscope according to the invention, a controllably adjustable (laser) beam expander can be arranged as a beam-shaping optical unit in the illumination beam path or in the detection beam path of the microscope. Beam expanders are typically based on telescopic constructions. The confocal volume can likewise be increased or decreased by the effect of the settings of a motorized variable beam expander.

In a further embodiment of the microscope according to the invention, a slit stop can be arranged as a beam-shaping optical unit in the illumination beam path or in the detection beam path, the effect of which creating a PSF that is elongate transversely to the beam path.

The presence of an optical element modulating the PSF in space and/or time is likewise possible, for example a spatial light modulator (SLM) or correspondingly controllably adjustable phase masks and/or phase masks that can be controllably brought into and out of the beam path.

The aforementioned stops or optical elements can be advantageously controlled, and the optical effect thereof can be influenced in a targeted manner.

In further configurations, the invention can also be realized using multiphoton excitation, for example. In this case, it is possible to generate a confocal volume in the sense of the FCS by directing excitation radiation into a volume in a directed manner, and it is only possible to even excite detection radiation when photons are incident, for example at a fluorophore, at the same time. Such a procedure does not require confocal detection.

The invention is explained below on the basis of exemplary embodiments and figures.

In the exemplary embodiments and figures, identical technical elements are provided with the same reference signs.

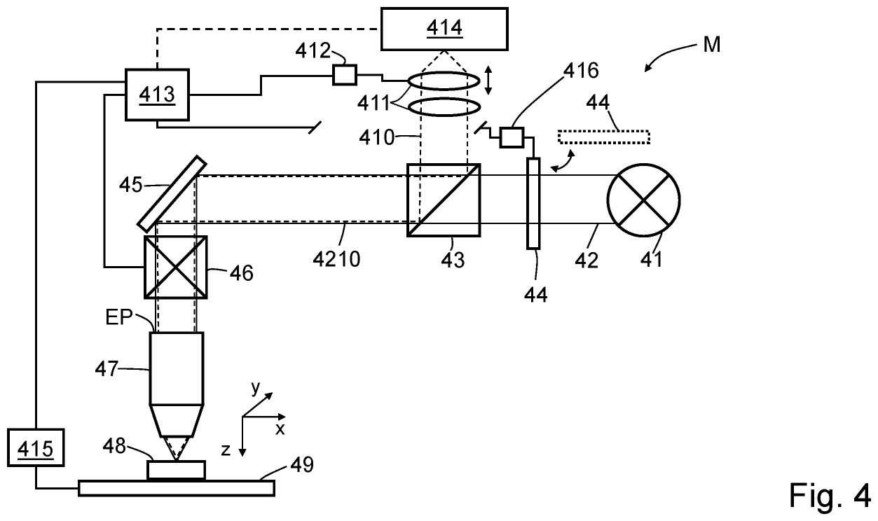

A detector 414 in the form of what is known as an Airyscan detector can be seen in FIG. 2, in a plan view of its detection plane or detection surface. The detector 414 of this embodiment comprises 32 detector elements 1 to 32 and can be used as a spatially resolving detector 414. The acquired brightness information (measurement values) of the detector elements 1 to 32 are readable individually and can also be combined with one another as desired (“binning”). The extent of the beam of detection radiation (see also FIG. 4) can for example be selected such that it is incident on the detection plane with 1.25 Airy units (AU). For example, each of the detector elements 1 to 32 can cover a portion of 0.2 AU. The central detector element denoted by reference sign “1” is located on the optical axis (oA) of the detection beam path 410 (see FIG. 4).

FIG. 3 shows a further embodiment of a spatially resolving detector 414 in a row and column arrangement of the detector elements 1 to 31, as can be realized, for example, in a SPAD array, a CMOS chip or an sCMOS chip. Here, too, the pieces of brightness information from the detector elements 1 to 31 are readable individually or can be combined as desired.

FIG. 4 schematically shows a microscope M according to the invention. The latter comprises a light source 41, for example a laser light source, starting from which a beam of excitation radiation (illumination radiation) is emitted and guided along an illumination beam path 42 (excitation beam path 42). Optional optical elements for shaping and/or collimation of the excitation radiation are not shown. Arranged in the illumination beam path 42 is optionally a beam-shaping optical unit 44 for the controlled change of an extent of the beam, which in the exemplary embodiment is in the form of a controllably adjustable stop. In further embodiments, a turret or a slide can also be present, by means of which different stops can be introduced into the illumination beam path 42. Alternatively, the beam-shaping optical unit 44 can also be a controllably adjustable telescope, a beam expander, a zoom optical unit, an acousto-optic element or an SLM.

The beam-shaping optical unit 44 can be moved out of the illumination beam path 42 by means of a drive 416 (indicated by a dashed line) to effect different numerical apertures, within whose respective angular ranges the excitation radiation can be directed into a sample 48 to be imaged. The beam-shaping optical unit 44 may be adjustable in further embodiments with regard to its transmissivity for the excitation radiation, in particular with regard to a hole diameter (pinhole, iris diaphragm) or the length and width of a slit or transparent region (adjustable slit aperture, acousto-optic element) or the angle orientation and the phase information.

After passing through the beam-shaping optical unit 44, the excitation radiation is incident on a main dichroic beam splitter 43, which is transmissive for the excitation radiation and allows it to pass. Downstream of the main dichroic beam splitter 43, the excitation radiation passes through a portion of the beam path of the microscope M which is referred to as the common beam path 4210 and along which the excitation radiation and detection radiation (see below) are guided together or can be guided together.

By means of a scanner 46 arranged thereafter, the beam of the excitation radiation which was previously diverted by means of a mirror 45 can be controllably deflected and be directed into the entrance pupil EP of an objective 47. The mirror 45 allows a compact design and may be omitted in further embodiments of the device if no diversion of the illumination beam path 42 is required or envisaged.

The excitation radiation, which is set by the effect of the beam-shaping optical unit 44 in its lateral extent and controllably deflected by means of the scanner 46, is focused by the effect of the objective 47 into a sample region in which the sample 48 to be imaged may be present on a sample stage 49. In combination with the confocal detection, the excitation radiation radiated in with such focusing brings about a confocal excitation volume.

Detection radiation brought about in the sample 48 by way of the excitation radiation in the confocal excitation volume is captured by the objective 47 and guided along a detection beam path 410 (shown with dashed full lines), which coincides with the excitation beam path 42 up to the main dichroic beam splitter 43.

In further embodiments of the apparatus according to the invention, the detection radiation can be captured by means of a further objective (not shown). In such a case, the excitation beam path 42 and the detection beam path 410 can be completely separated from one another or they are combined again, for example by means of a further dichroic beam splitter (not shown), to form the shared beam path 4210.

In the illustrated exemplary embodiment, the detection radiation is converted into a stationary beam as a consequence of passing through the scanner 46 (“descanned”) and reaches the main dichroic beam splitter 43. The latter is reflective at the wavelength of the detection radiation, which differs from the wavelength of the excitation radiation. The detection radiation reflected at the main dichroic beam splitter 43 reaches a zoom optical unit 411 optionally present in the detection beam path 410. The zoom optical unit is controllably adjustable by means of a zoom drive 412. In further embodiments, the transmissivity and the reflectivity of the main dichroic beam splitter 43 may also be implemented in reverse, with the result that the excitation radiation is reflected and the detection radiation is allowed to pass through. The beam paths 42 and 410 must then be designed accordingly.

The beam-shaping optical unit 44, the scanner 46, the zoom drive 412, and the drives 415 and 416 and optionally the light source 41 are suitably connected to an analysis and control unit 413 for exchanging data and control commands. For example, the analysis and control unit 413 is a computer or a suitable control circuit and is configured to carry out the method according to the invention. In particular, it is configured to carry out and assess cross-correlations of image data from the above-described pairs, extended pairs and/or groups, and optionally configured to determine diffusion coefficients, flow speeds and flow directions of moving objects, local temperatures and/or local viscosities.

The zoom optical unit 411 is a means for controlled modification of an extent of the beam of the detection radiation, by means of which the extent of a beam of the detected detection radiation can be adapted to the size of a detection surface (detection plane) of a spatially resolving detector 414 also arranged in the detection beam path 410 in an intermediate image (“pinhole plane”). The aim is to illuminate the detection surface in full where possible or adapt the latter accordingly to the respective requirements. Accordingly, the detection radiation is directed at the detector 414 by means of the zoom optical unit 411 and adapted with regard to the extent of its beam by means of the zoom drive 412.

Optionally, the control unit 413 and the detector 414 can be interconnected, for example to allow the control unit 413 to generate control commands and/or validate these, on the basis of the acquired brightness information from the detector 414. For example, these control commands serve to control the light source 41, the means 44, the scanner 46, the zoom drive 412, and/or an optional drive 415 of the sample stage 49.

FIG. 5 to FIG. 7 in each case specify technical circumstances on the basis of the detector elements 1 to 32 of a detector 414 of the Airyscan detector type. Similar applies to detectors 414 of the type presented in FIG. 3. In a subsequent specification of the numbers of the relevant detector elements, reference is made to FIG. 2. The central detector element 1 is shown in the following FIG. 4 to FIG. 6 without a pattern fill for better clarity.

FIG. 5 once again shows a plan view of the detection surface of the detector 414 (rotated approximately 30° counterclockwise vis-à-vis FIG. 2). For the purposes of the description, orientations are defined proceeding from detector element 1 and, by way of example, denoted by degree values between 0° and 180° and −60° and 120°. Arrows are used to show three pairs of selected detector elements by way of example, wherein the start and end of each arrow indicates one partner of the relevant pair. The arrows specify the forward direction (first direction) and the back direction (second direction) of the total of six cross-correlations carried out on the basis of the intensity values (brightness values, measurement values) acquired by the partners of each pair. The different pattern fills emphasize three rings which are formed by detector elements arranged around the central detector element 1.

If only the pairs and directions shown by way of example in relation to FIG. 5 are supplied to the ascertainment of cross-correlations, then the efficiency of the method is low since acquired measurement values from other detector elements remain unconsidered. However, if use is made of the circumstance that the radius of the confocal volume w₀ for the central detector element 1 and the inner two rings of the detector elements 2 to 19 is approximately constant, then it is possible to select and define nine pairs of detector elements for each orientation, as illustrated by way of example in FIG. 6 for the orientation 180°-0° (only the forward direction is shown). The nine curves obtained therefrom can be averaged and fitted using Equation (2) or the modifications thereof (see above). The use of the plurality of curves improves the signal-to-noise ratio.

Cross-correlations for the total of five other forward and backward directions with the orientation 180°-0°; −120°->60° and −60°->120° (not shown) can be calculated in the same way. The image data from detector elements 20 to 32 can be discarded or separately combined by calculation.

In a further method configuration, the measurement values from the detector elements 20 to 32, or 19 to 31 according to FIG. 3, can also be used, for example depending on a selected imaging ratio of the zoom optical unit 411 (see FIG. 4) and the resultant signal strengths of the individual channels (detector elements).

In an alternative configuration of the method according to the invention, a plurality of detector elements are combined to form extended pairs. In FIG. 7, this is shown by way of example for detector elements 5, 6, 7, 16, 17 and 18 as elements of the one partner of the extended pair and detector elements 2, 3, 4, 10, 11 and 12 as elements of the other partner of the extended pair. In this example, cross-correlations can be calculated for the directions 180°->0° (common first direction, forward direction) and 0°->180° (common second direction, back direction), wherein the measurement values from the elements of each partner of the extended pair were previously averaged. The centers of the respective partners of the extended pair are spaced apart from one another by more than the extent of one of the detector elements 1 to 32.

The example of two cross-correlation curves plotted over the correlation period (lag time) is used to illustrate variant 3 for ascertaining the time offset (FIG. 8). A displacement of the curves occurring along the abscissa (lag time) corresponds in terms of its maximum to twice the time offset t_{delay}. The displacement can be ascertained on the basis of the function values of the curves or on the basis of a graphical representation, and the time offset t_{delay} can be calculated.

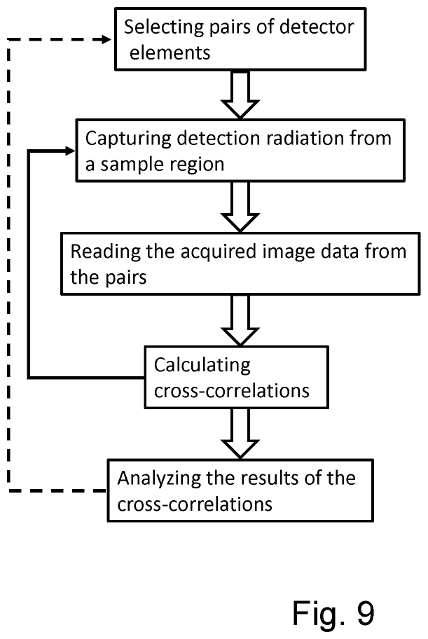

FIG. 9 is used to illustrate a possible configuration of the method according to the invention. Initially, at least one pair of detector elements whose measurement values are intended to be used in the following steps is selected and defined. Similar applies to groups of pairs or to extended pairs. A detection radiation coming from the sample space is captured and the resultant measurement values of the selected pairs are read in order to be able to supply these to the calculation of the corresponding cross-correlations, in each case in the forward direction and back direction. The results of the cross-correlations are subsequently analyzed.

The acquisition of further data and/or selection of new pairs of detector elements is optionally possible following the calculation of the cross-correlations or in response to the results of the analysis.

The practical implementation of the method according to the invention can be assisted by means of menu navigation (“wizard”), which in each case proposes appropriate options for the individual method steps to a user.

The use of the menu navigation means that some technical requirements are specified by the user. For example, the latter specifies objectives to be used, supported laser lines and the correct beam path (illumination and/or detection). In addition to that, or as an alternative, dyes or fluorophores to be used can be specified by the user. Suitable laser lines, beam paths and/or control parameters are accordingly proposed or set by means of the menu navigation. Moreover, a correct alignment of the detector 414 to be used is necessary in order to subsequently obtain good quality measurement values and in order to hence create the possibility of calculating a plurality of cross-correlations.

A reference image of the sample can be acquired in a further step. For example, images of the sample at different wavelengths (“tracks”) can be recorded at one or more locations and can be displayed. A user and/or suitable programming (for example, image evaluation methods, use of artificial intelligence) can select at least one region of interest (ROI) on the basis of the displayed data. An advantage of using multiple wavelengths lies in a higher information density for the selection of the regions of interest to be carried out. An FCS measurement of the selected locations is subsequently carried out. This is implemented using only one wavelength.

The user can use the reference image as a map, on which they can define for example up to ten positions of in each case one spot (step 3). A corresponding symbol (for example: “spot selection icon”) reproduces the linked relationships between the selected spot positions and the image coordinates of the associated detector elements, in particular of the inner rings with the detector elements 1 to 19.

The quantity and/or quality of the acquired measurement values, optionally per spot, can be displayed graphically, for example by virtue of count data being displayed with different color codes. This allows the user to select the positions differently when necessary, optionally by resorting to the second track (see above). To optimize the CPM (counts per molecule), it is possible to update the intensity of a laser used to excite the detection radiation, a gain (e.g., high voltage of the PMT) and the observed z-position.

A fourth step of the menu navigation is only available if a reference image is present. Measurement values are stored in a metafile in each step. All values can be retrieved if the menu navigation is started another time.

### REFERENCE SIGNS

1 to 32 Detector elements
41 Light source
42 Illumination beam path, excitation beam path
43 Main dichroic beam splitter
44 Beam-shaping optical unit
45 Mirror
46 Scanner
47 Objective
48 Sample
49 Sample stage
410 Detection beam path
411 Zoom optical unit
412 Zoom drive
413 Control unit
414 Detector
415 Drive
416 Drive
4210 Common beam path

1. A method for determining properties of moving objects in a biological sample,
the method comprising:
A. detecting detection radiation from a confocal volume generated in the sample using a plurality of detector elements of a detector in the form of a detector array at multiple points in time over a measurement period, wherein the detector is arranged in a plane conjugate to the rear-side image plane of an objective and the measurement values from the detector elements are configured to be analyzed individually; and selecting at least one pair of detector elements, each partner of a pair being formed by at least one detector element or a plurality of detector elements being combined to form a respective one of the partners of an extended pair;
B. creating cross-correlations of the acquired measurement values from the detector elements of at least one pair or of the extended pair among themselves, wherein
in B, in B1, cross-correlations are calculated in a first direction to the further selected detector element starting from one of the selected detector elements;
in B, in B2, cross-correlations are additionally calculated in a second direction (back direction) to the first selected detector element starting from the further selected detector element;
C. defining multiple pairs or multiple extended pairs of detector elements, wherein the respective imaginary connecting lines between the centers of the pairs or extended pairs have at least two mutually different orientations;
D. ascertaining a time offset between signal patterns of the detector elements of the pairs or extended pairs; and
E. calculating a movement direction and/or a movement speed of an object on the basis of the ascertained time offsets of pairs or extended pairs, the associated connecting lines of which have different orientations.

2. The method according to claim 1, wherein each of the imaginary connecting lines has one of a total of three different orientations.

3. The method according to claim 2, wherein the orientations of the imaginary connecting lines are rotated by 120° relative to one another in each case.

4. The method according to claim 1, wherein the partners of a pair are spatially separated by at least one detector element not belonging to the pair in question.

5. The method according to claim 1, wherein a group of multiple pairs or multiple extended pairs of detector elements is defined, wherein the imaginary connecting lines of the centers of the pair pairs or extended pairs run parallel to one another.

6. The method according to claim 1, wherein-a mean value is formed from the cross-correlations of the first direction and/or the second direction created from the measurement values from the pairs or extended pairs.

7. The method according to claim 1, wherein for each orientation of the imaginary connecting lines, intensity profiles (intensity traces) of detector elements are created, cross-correlations are calculated therebetween and an ascertained maximum of the cross-correlations is stored as a time offset (t_{delayi}) in the respective orientation.

8. The method according to claim 1, wherein an autocorrelation is ascertained for the detector elements of a pair, an extended pair or a group using a fitting model; and cross-correlations with the time offset (t_{delayi}) are calculated as fit parameters on the basis of the autocorrelations between the partners of the pair, of the extended pair or of the group ascertained in each case.

9. The method according to claim 8, wherein the following relationship is used
$${G}_{f l o w} ( τ ) = A exp ( - \frac{{τ}^{2}}{{t}_{f}^{2}} )$$
as the fitting model, where t is the correlation or “lag” time, A is the amplitude of the correlation and tr is the mean dwell time of the object in the confocal volume.

10. The method according to claim 8, wherein a size distribution and/or of movement profiles of the objects is additionally integrated in the fitting model.

11. The method according to claim 1, wherein cross-correlation curves for the first direction and for the second direction are created on the basis of the cross-correlations between the detector elements of at least one pair per orientation, and a time shift is ascertained for the cross-correlation curves, wherein the time shift corresponds to twice the time offset (t_{delayi}).

12. A microscope for determining properties of moving objects in a biological sample, the microscope comprising:
a sample region for arranging a biological sample;
an objective for capturing a detection radiation coming from a confocal volume created in the sample;
a detection beam path along which the captured detection radiation is directed to a detector in the form of a detector array having a plurality of detector elements, wherein the detector is arranged in a plane conjugate to the rear-side image plane of the objective, and the measurement values from the detector elements each are configured to be read individually; and
an analysis and control unit configured for carrying out the method according to claim 1.
